(19) United States
(12) Patent Application Publication
(10) Pub. No.: US 2004/0030441 A1
(43) Pub. Date: Feb. 12, 2004

(54) Closed loop material pressure control for the encapsulation process of electronic components

(75) Inventors: Henry Michael Bullock, Fountain Inn, SC (US); Douglas Clinton Byrd JR., Simpsonville, SC (US); David Bruce Jacobs, Greer, SC (US)

Correspondence Address: BANNER & WITCOFF, 1001 G STREET N W, SUITE 1100, WASHINGTON, DC, 20001, US

(73) Assignee: Kemet Electronics Corporation, Greenville, SC

(21) Appl. No.: 10/216,323

(22) Filed: Aug. 12, 2002

(51) Int. Cl. B29C 39/00

(52) U.S. Cl. 700/197; 264/40.3

(57) ABSTRACT

A transfer mold apparatus comprising at least one mold cavity, at least one resin chamber, and at least one channel communicating between the at least one mold cavity and the at least one resin chamber; a piston in communication with each resin chamber to force the resin through the at least one channel into the at least one mold cavity; and a device to drive the piston; further comprising at least one pressure transducer connected to at least one channel and positioned to determine the pressure in the channel. A method for encapsulating electrical components comprising placing resin into a chamber of a molding device; applying an compressive force to the resin to force the resin through channels into mold cavities; measuring the pressure in at least one channel using a pressure transducer; determining the amount of compressive force to apply to the resin based on the pressure measured by the pressure transducer; and adjusting the compressive force based thereon.

### FIELD OF THE INVENTION

The invention relates to pressure control system for the encapsulation of electronic components.

### BACKGROUND OF THE INVENTION

Thermoset resin transfer molding (RTM) has long been the industry standard process for the encapsulation packaging of a wide variety of electronics components, including integrated circuits, capacitors, resistors, inductors, and small transformers.

Attention is drawn to FIG. 1. Conventionally, the molding process employs heated mold device 1, typically in two parts, an upper part and a lower part. Mold cavities (not shown in FIG. 1) are contained within the mold device. Heated compression chambers 3 communicate with the mold cavities via a series of relatively small diameter channels 4 cut into the mold surface 5. Objects to be encapsulated are placed within the mold cavities and molding resin, typically in the form of pellets, is placed within compression chambers 3. The mold device is then closed and clamped shut, usually by hydraulic pressure.

The thermoset resin (molding compound) is heated and transferred from the compression chambers 3 to the mold cavities via the channels 4 cut into the mold faces 5 by applying hydraulic pressure upon pistons 8 contained within the compression chambers 3. The pistons 8 transfer the pressure to the molding resin thus forcing the resin through channels 4 into the mold cavities. The resin encapsulates the objects within the cavities and cures within a short time (10 seconds to 10 minutes) due to the elevated temperature of the resin. Once the resin is sufficiently cured, the encapsulated objects may be removed from the mold for further processing.

Pistons 8 are typically operated using a plunger nest 6. The plunger nest supports the pistons or “plungers”. A linear transducer 7 relates the position of the “plunger nest” supporting the pistons, which compress the molding compound. (In this configuration, the pistons move together.)

Alternatively, the compression/transfer of the resin to the mold cavities may be accomplished using a servo motor driven piston instead of a hydraulically driven piston. This piston compresses the resin thus transferring the resin to the mold cavities.

Resins used for molding compounds, such as epoxies, tend to exhibit a relatively high viscosity and the forces that occur during the molding process are less predictable than are the forces encountered in pumping water or hydraulic oil through relatively fine channels under high pressure. With older molding systems employing relatively simple mold designs, i.e., relatively few components molded at a time, and used for relatively large and mechanically robust components, sufficient control of the molding compound transfer to the molding cavities could be accomplished by monitoring the pressure of the hydraulic oil driving the piston used to compress the transfer resin. This avoids excessive pressure, which can damage the components being molded, or inadequate pressure, which can result in excessive transfer times and/or incomplete filling of the mold cavities.

Electronic components continue to be made smaller in size and more susceptible to mechanical damage. Simultaneously the demand for lower production costs has driven mold sizes toward larger molds having a greater number of cavities and has also driven molding cycle time downward from several minutes to less than one minute. Thus, the problem of controlling material transfer rates and damage to individual components from excessive resin pressure has grown much more difficult. This difficulty in controlling the pressure to which the components are exposed during transfer molding is increased by the trend toward multiple compression cylinders, used to press the molding resin into the mold cavities, and shorter gel time/shorter “spiral flow” molding resins which require less time to cure, reducing molding cycle time, but which also tend to exhibit a greater increase in viscosity during the molding process and which tend to be much more sensitive to storage temperature. For example, four hours additional storage at room temperature prior to molding may decrease the “spiral flow” of a molding epoxy resin by 10% i.e., for the same applied pressure the material flows 10% less far in a cavity of uniform cross-section due to partial curing on standing at room temperature.

### BRIEF SUMMARY OF THE INVENTION

A first embodiment is directed to a transfer mold apparatus comprising at least one mold cavity, at least one resin chamber, and at least one channel communicating between the at least one mold cavity and the at least one resin chamber; a piston in communication with each resin chamber to force the resin through the at least one channel into the at least one mold cavity; and a device to drive the piston; further comprising at least one pressure transducer connected to at least one channel and positioned to determine the pressure in the channel.

A second embodiment is directed to a method for encapsulating electrical components comprising placing resin into a chamber of a molding device; applying compressive force to the resin to force the resin through at least one channel into mold cavities; measuring the pressure in at least one channel using at least one pressure transducer; determining the amount of compressive force to apply to the resin based on the pressure measured by the at least one pressure transducer; and adjusting the compressive force based thereon.

### BRIEF DESCRIPTION OF THE DRAWINGS

FIG. 1 shows a compression chamber in accordance with the prior art and useful in the invention.

FIG. 2 shows a graph of actual material pressure vs. hydraulic cylinder pressure in an open loop system.

FIG. 3 shows a graph of actual material pressure in a closed loop system.

FIG. 4 shows a graph of actual material pressure vs. hydraulic cylinder pressure in a closed loop system.

FIG. 5 shows a graph of actual material pressure on mechanical closed loop system.

FIG. 6 shows a top view of the compression chamber containing a pressure transducer.

FIG. 7 shows a molding device utilizing a hydraulic transfer cylinder.

FIG. 8 shows a molding device utilizing a servo/stepper motor and controller.

### DETAILED DESCRIPTION OF THE INVENTION

Recently, a pressure transducer was developed that can withstand a harsh environment such as that inside a mold cavity. Utilizing such a pressure transducer in molding/encapsulation technology, it was discovered that the actual encapsulation pressure inside the mold varied from cycle to cycle, although the applied hydraulic force on the transfer mechanism was held constant.

It was further discovered that, by employing a pressure transducer, the rate of resin transfer and the maximum pressure to which molded products are exposed can be controlled much more closely than previously possible.

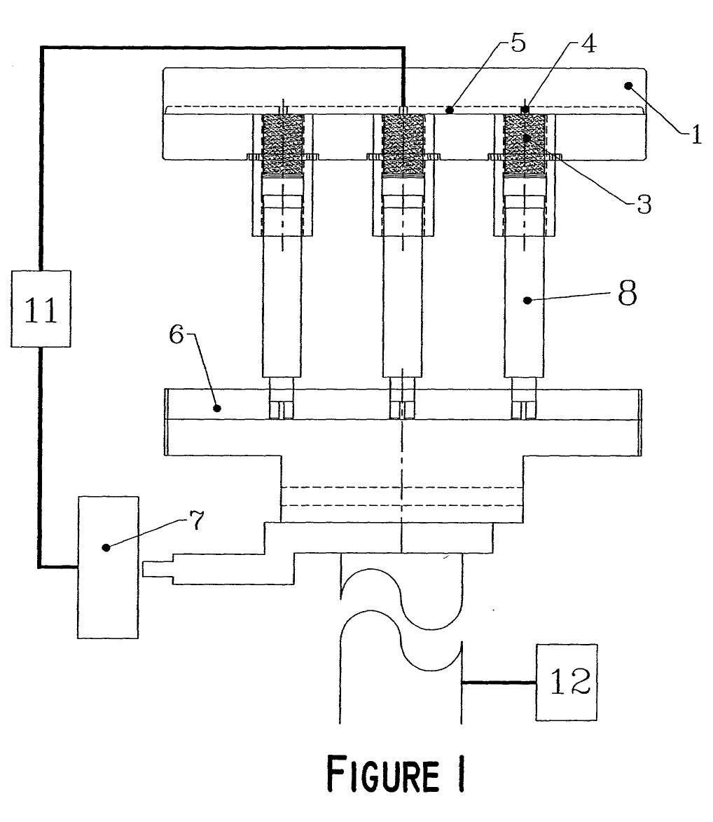

Attention is drawn to FIG. 1. Similar to the prior art, the molding device 1 has mold cavities (not shown in FIG. 1). The mold device generally has an upper part and a lower part that separate to place the objects to be encapsulated into the mold cavities and then to remove the encapsulated object. The mold device 1 is preferably heated. Compression chambers 3 communicate with the mold cavities via a series of relatively small diameter channels 4 cut into the mold surface 5. The compression chambers 3 are preferably heated.

Objects to be encapsulated are placed within the mold cavities. Molding resin is placed within compression chambers 3. The objects may be any suitable objects. In particular, the objects are preferably electronic components, such as capacitors. The molding resin may be any resin suitable for encapsulation of the objects such as epoxy resins.

The mold is then closed and clamped shut by any suitable means such as hydraulic pressure. Pressure, such as hydraulic pressure, is applied to pistons 8 contained within the compression chambers 3. The pistons 8 force the resin from the compression chambers 3 to the mold cavities 1 via the channels 4 cut into the mold faces 5. Preferably, the resin is heated prior to being compressed by the pistons. The compression chamber and the mold cavities may be heated in any suitable manner. The pistons 8 transfer pressure to the molding resin thus forcing through the resin through channels 4 into the mold cavities.

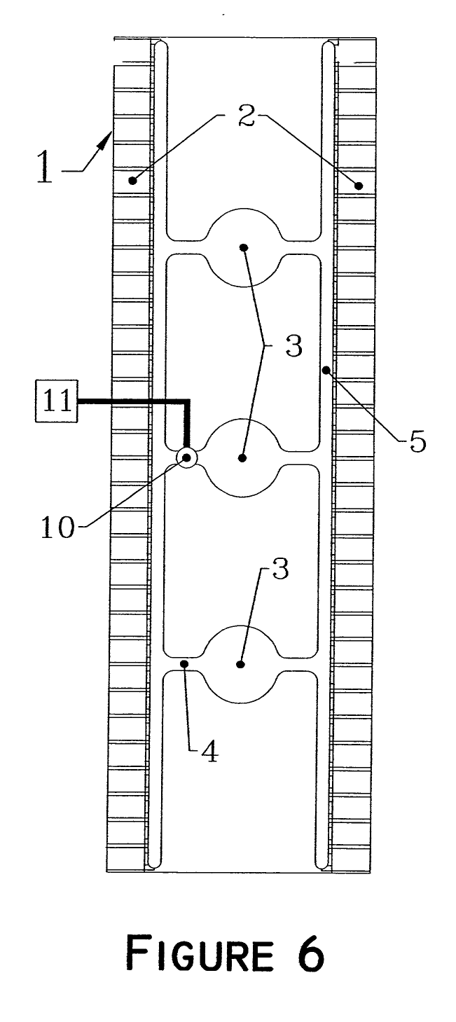

FIG. 6 shows mold cavities 2 in communication with resin distribution channels 4. At least one pressure transducer 10 is mounted in communication with at least one of the resin distribution channels 4 downstream of the compression chamber 3 containing the molding resin. The pressure transducer 10 is positioned in a convenient location in the channel.

The molding device may contain only one cavity, but preferably the device contains multiple cavities, typically from about 50 to about 200 cavities. The molding device contains at least one compression chamber. Typically there is one chamber per 1 to about 100 mold cavities. The number generally depends on the size of the part being encapsulated. Some standard mold devices contain two compression chambers and 132 cavities or three compression chambers and 64 cavities.

The molding device may contain a single pressure transducer or several pressure transducers. There may be one pressure transducer per mold cavity. There may be several pressure transducers associated with one chamber, one pressure transducer associated with several chambers, or one pressure transducer associated with one chamber.

A signal from the pressure transducer 10 is amplified and sent to a system to calculate information regarding the amount of compressive force to apply to the piston. This system is preferably a PLC (Programmable Logic Controller) or a computer, indicated generally by box 11 in FIGS. 1 and 6, where a signal from the pressure transducer is fed into a Proportional-Integral-Derivative (PID) calculation. The PID calculates and controls the amount of force to be applied to, or the position of the piston, in each compression chamber. This information is provided to the control valve that controls a hydraulic transfer cylinder that operates pistons 8 or this information is provided as electric current to the servomotor that operates the pistons 8. An additional pressure transducer, shown generally by 12, may be attached to the hydraulic cylinder containing the pistons 8 in order to measure the hydraulic pressure or molding compound pressure.

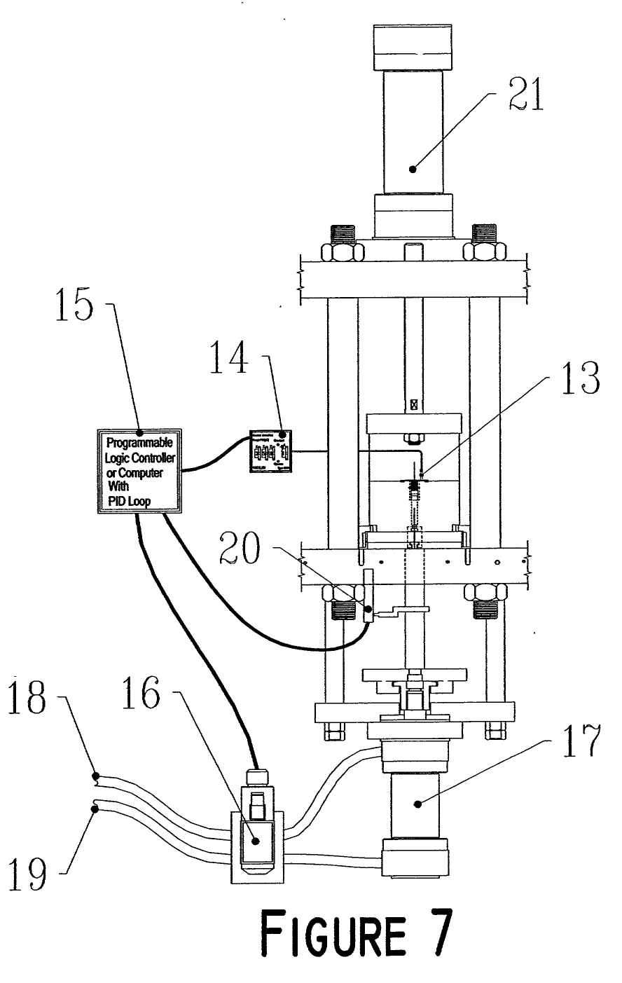

FIG. 7 shows one embodiment of the closed loop molding apparatus in accordance with the invention utilizing a hydraulic transfer cylinder. The pressure transducer 13 is connected to amplifier 14, which in turn is connected to Programmable Logic Controller (PLC) or computer 15. A linear transducer for speed and location feedback 20 is also connected to the PLC or computer with PID loop 15. The PLC or computer 15 relays information to a proportional/servo hydraulic control valve 16 which controls the pressurized hydraulic oil line 18 from the pump (not shown) and return oil line 19 to the oil storage tank (not shown). Oil is supplied to the hydraulic transfer cylinder 17. A hydraulic clamping cylinder 21 opens and closes the die/mold.

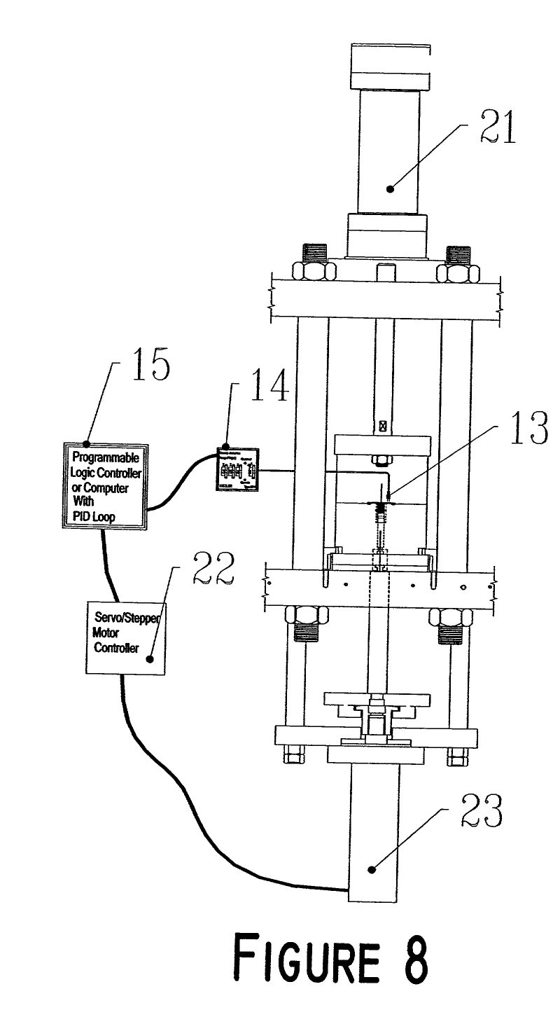

FIG. 8 shows another embodiment of the closed loop molding apparatus in accordance with the invention utilizing a servomotor. The pressure transducer 13 is connected to amplifier 14, which in turn is connected to Programmable Logic Controller (PLC) or computer with PID loop 15. The PLC or computer 15 relays information to a servo/stepper motor controller 22, which controls the servo/stepper motor 23. A hydraulic clamping cylinder 21 opens and closes the die/mold.

During the transfer/injection process, the linear movement and pressure are monitored and adjustments are made to insure both are on target. The material pressure is generally the dominating factor during the process. When the velocity starts to slow due to increased pressure because the cavities are full, the set point for the maximum material pressure is reached and held for a specific time.

The use of the feedback loop, described above, facilitates control of the pressure to which the components undergoing encapsulation via the molding process are exposed to a much greater degree than is possible without such a feedback control loop in place. Preferably, a pressure within ⁺/−10%, preferably within ⁺/−5%, preferably within ⁺/−4%, more preferably within ⁺/−3%, and most preferably within ⁺/−2% variation from mean values of pressure extremes is maintained in the channel. This allows a more repeatable and accurate transfer system.

### EXAMPLE 1

A multi-cavity transfer mold used to encapsulate electronics components, as described above, was equipped with a Kistler No. 6167A0.6 pressure transducer. The pressure transducer was attached to the channel used to convey the molding compound from the heated chamber to the mold cavities. The pressure transducer was placed immediately adjacent to the mold cavities such that the pressure of the material being forced into the mold cavities was communicated to the pressure transducer, as illustrated in FIG. 1. An additional pressure transducer was attached to the hydraulic cylinder containing the piston, which compresses the molding compound to force it into the mold cavities. The hydraulic pressure driving the piston is communicated to this additional pressure transducer.

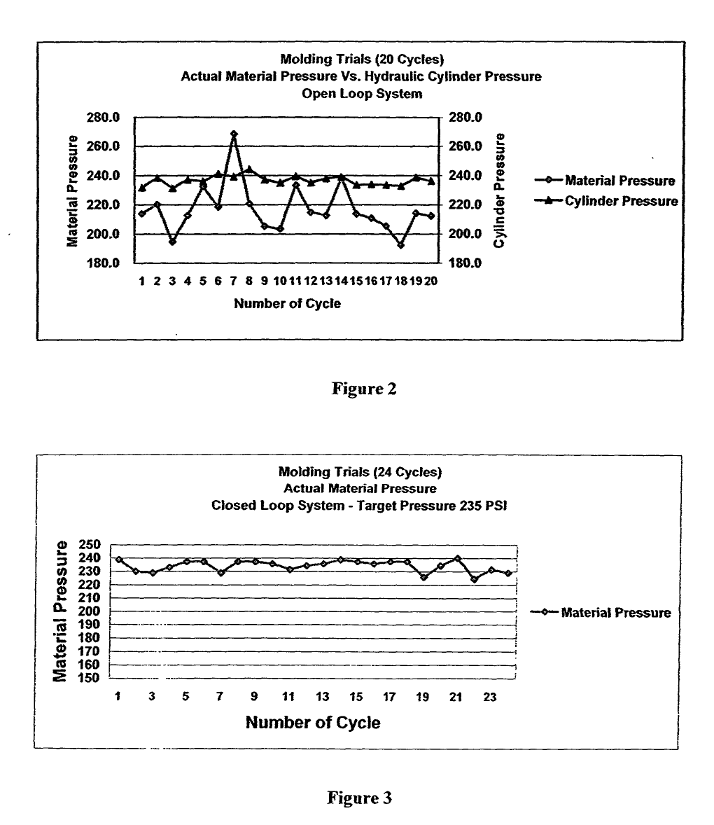

The pressure of the hydraulic fluid driving the piston compressing the molding compound during transfer to the mold cavities and the resulting molding compound pressure at the channel adjacent the mold cavities is shown graphically in FIG. 2. The graph shows that, although the cylinder pressure was held to within 15 pounds per square inch (230 psi to 245 psi), the resulting material pressure within the cavities varied from 190 psi to 270 psi, or 80 psi, from run to run (cycle to cycle) over the course of 20 molding runs (cycles). Thus, although the hydraulic pressure was controlled within about ⁺/−3%, the material pressure during molding varied by ⁺/−17% (variation from mean values of pressure extremes).

### EXAMPLE 2

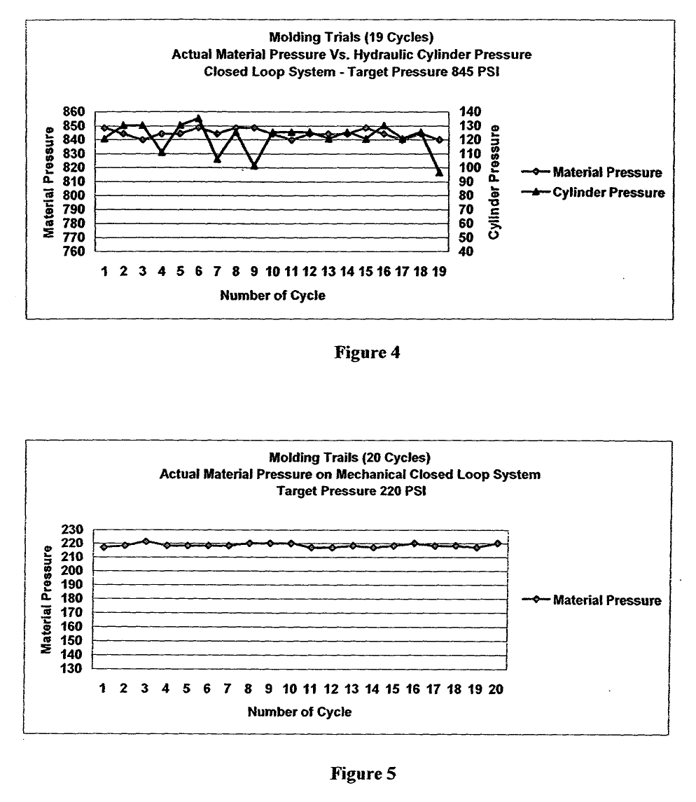

FIG. 3 illustrates the greatly improved control of the pressure of the molding compound within the mold when utilizing the feedback loop of the present invention. The hydraulic pressure on the piston compressing the molding compound is varied during the molding process so as to minimize the variation in pressure on the molding compound during the molding process. The graph shows that the molding compound pressure varied from 225 psi to 240 psi, or 15 psi, or ⁺/−3% over 24 molding cycles. This is in contrast to ⁺/−17% with the same mold operated in the traditional manner (i.e., with constant pressure in the hydraulic cylinder).

### EXAMPLE 3

The invention may be applied over a wide pressure range, as is illustrated in FIG. 4. The molding compound pressure varied between 840 psi and 850 psi which is a difference of 10 psi or less than ⁺/−1% over 19 molding runs with a mean pressure in excess of three times the mean pressure maintained in Example 2.

### EXAMPLE 4

The invention applies to electronically controlled servomotor driven compression of the molding compound as well as hydraulically driven systems. FIG. 5 depicts graphically the mold pressure results of 20 molding runs using electronically controlled servo motor driven compression of the molding compound in combination with the pressure feedback loop of the present invention. The molding pressure was maintained between approximately 217 psi and 222 psi, or a 5 psi range or approximately ⁺/−2½%. Again, this is much closer control than is possible with a traditional, constant hydraulic pressure system, as demonstrated in Example 1.

The system of the invention increases precision, sensitivity, and control of encapsulant pressure. The transducer provides real-time encapsulant pressure information to the control system used in the PID calculation in determining the force to be applied by the hydraulic or mechanical system. The system modulates hydraulic pressure (hydraulic system) or torque on the motor (mechanical system) to accomplish the required encapsulant pressure system. In addition, the system is capable of multiple pressure, position, and velocity settings for each cycle of the encapsulation.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A transfer mold apparatus comprising at least one mold cavity, at least one resin chamber, and at least one channel communicating between the at least one mold cavity and the at least one resin chamber; a piston in communication with each resin chamber to force the resin through the at least one channel into the at least one mold cavity; and a device to drive the piston; further comprising at least one pressure transducer connected to at least one channel and positioned to determine the pressure in the channel.

2. The apparatus of claim 1 wherein the at least one pressure transducer is connected to a system to calculate information regarding the amount of compressive force to apply to the piston, the position of the piston, or both; wherein the system conveys the information to the device to drive the piston.

3. The apparatus of claim 2 wherein the system comprises a computer or a programmable logic controller that performs a proportional-integral-derivative calculation.

4. The apparatus of claim 1 wherein each chamber is heated.

5. The apparatus of claim 1 wherein each mold cavity is heated.

6. The apparatus of claim 1 wherein the device to drive the piston is hydraulic.

7. The apparatus of claim 1 wherein the device to drive the piston is a servo-electric motor.

8. The apparatus of claim 1 comprising at least two channels connected to each cavity.

9. The apparatus of claim 1 wherein the pressure transducer is connected to the system through an amplifier.

10. A method for encapsulating electrical components comprising placing resin into a chamber of a molding device; applying a compressive force to the resin to force the resin through channels into mold cavities; measuring the pressure in at least one channel using a pressure transducer; determining the amount of compressive force to apply to the resin based on the pressure measured by the pressure transducer; and adjusting the compressive force based thereon.

11. The method of claim 10 further comprising heating the chamber to heat the resin.

12. The method of claim 10 further comprising heating the mold cavities.

13. The method of claim 10 further comprising determining the amount of compressive force to apply to the resin using a computer or a programmable logic controller and a proportional-integral-derivative calculation.

14. The method of claim 10 further comprising using a piston to apply the compressive force to the resin.

15. The method of claim 11 wherein the compressive force is adjusted to maintain a pressure within ⁺/−10 variation from mean values of pressure extremes in the channel.

16. The method of claim 15 wherein the compressive force is adjusted to maintain a pressure within ⁺/−5%.

17. The method of claim 16 wherein the compressive force is adjusted to maintain a pressure within ⁺/−4%.

18. The method of claim 16 wherein the compressive force is adjusted to maintain a pressure within ⁺/−3%.
